(19) United States
(12) Patent Application Publication
(10) Pub. No.: US 2015/0010457 A1
(43) Pub. Date: Jan. 8, 2015

(54) PREPARATION OF AN ELECTRODE-ACTIVE MATERIAL USING DECOMPRESSION EQUIPMENT

(71) Applicant: HANWHA CHEMICAL CORPORATION, Seoul (KR)

(72) Inventors: Ki Taeg Jung, Daejeon (KR); Sei Ung Park, Daejeon (KR); Kyu Ho Song, Daejeon (KR); Seong Jae Lim, Daejeon (KR); Kee Do Han, Daejeon (KR)

(73) Assignee: HANWHA CHEMICAL CORPORATION, Seoul (KR)

(21) Appl. No.: 13/885,596

(22) PCT Filed: Jan. 14, 2013
(86) PCT No.: PCT/KR2013/000275

§ 371 Date: May 15, 2013

(30) Foreign Application Priority Data
Mar. 19, 2012 (KR) 10-2012-0027525

(51) Int. Cl. C01B 25/45; B01J 19/00; H01M 4/58

(52) U.S. Cl. CPC C01B 25/45; H01M 4/5825; B01J 19/0006
USPC 423/306; 422/129; 422/112

(57) ABSTRACT

An apparatus for preparing an electrode-active material, comprising a reactor that produces the electrode-active material by using a high-temperature high-pressure hydrothermal synthesis method; and decompression equipment that decreases the pressure of a fluid containing the electrode-active material. The decompression equipment includes a pipe-type or a tube-type decompressor.

### TECHNICAL FIELD

The present invention relates to an apparatus and a method for preparing an electrode-active material by a hydrothermal synthesis method by using decompression equipment.

### BACKGROUND ART

Electrode-active materials can be prepared in various ways. As methods for preparing electrode-active materials of secondary batteries, a solid state method, a co-precipitation method, a hydrothermal method, a high-temperature high-pressure hydrothermal method, a sol-gel method, an alkoxide method, and the like are used.

In the case of preparing a cathode-active material for a lithium secondary battery, a high-temperature high-pressure hydrothermal synthesis method is advantageous in that the crystallinity of particles can be highly improved while the average size of primary particles is in the range of tens or hundreds of nano meters.

With respect to high-temperature high-pressure hydrothermal synthesis methods, many studies are being conducted to establish the mixing and reacting conditions for reactants. Various studies are also being conducted on the crystallinity of particles. However, studies on continuous-type preparation processes of cathode-active materials for secondary batteries which adopt high-temperature high-pressure hydrothermal synthesis methods are few in number: only some studies are in progress and they are directed to methods of mixing and inputting reactants.

Although continuous-type high-temperature high-pressure hydrothermal synthesis methods have many advantages, they have problems of reducing process stability.

Specifically, the cathode-active material for a lithium secondary battery is prepared in a reactor by a continuous-type high-temperature high-pressure hydrothermal synthesis method, and the prepared cathode-active material in a high-pressure state is decompressed nearly to atmospheric pressure with decompression equipment and is then concentrated by a concentrator. At this time, a change in the pressure of the decompression equipment may affect the reactor and thus causes changes to temperature and pressure inside the reactor. Such changes in the temperature and the pressure inside the reactor influence the quality of the primary particles of the cathode-active material produced in the reactor. Accordingly, changes in the temperature and the pressure inside the reactor make it difficult to continuously produce the cathode-active material under stable conditions and thus it is necessary to repeatedly stop and restart the manufacturing process.

Meanwhile, although the primary particles of the cathode-active material synthesized in the reactor are nano meters in size, the particles are in the form of agglomerates. If these agglomerated particles are not deagglomerated, the average size of the primary particles increases, and the agglomerates may plug the filters of a concentrator or other passages in the concentrator. Further, if the primary particles produced in the reactor are not deagglomerated, the average size of the particles of the final product increases, and if this material having a large size is used as an electrode material, the battery's performance deteriorates.

Due to such obstacles to the process, the continuous operation of a concentrating facility becomes difficult, and the synthesis conditions of the primary particles of the cathode-active material continuously change, necessitating the repeated stops and starts of the process and making it difficult to prepare the cathode-active material under identical conditions.

Accordingly, when an electrode-active material is prepared by a continuous-type high-temperature high-pressure hydrothermal synthesis method, the deagglomeration of the agglomerates of primary particles is needed for the stable operation of the process and for the continuous operation of the concentrating facility.

### DISCLOSURE OF INVENTION

### Technical Problem

An object of the present invention is to stably maintain the synthesis conditions and ensure the operational stability of the synthesis process in a continuous process for preparing an electrode-active material which uses a high-temperature high-pressure hydrothermal synthesis method.

### Solution to Problem

The present invention provides an apparatus for preparing an electrode-active material. The apparatus includes a reactor that produces the electrode-active material by a hydrothermal synthesis method; and decompression equipment that decreases the pressure of the fluid containing the electrode-active material. The decompression equipment includes a pipe-type or a tube-type decompressor.

The present invention provides a method for preparing an electrode-active material. The method includes forming the electrode-active material by a high-temperature high-pressure hydrothermal synthesis method; and decreasing the pressure of the fluid containing the electrode-active material by using decompression equipment. The decompression equipment includes a pipe-type or a tube-type decompressor.

### Advantageous Effects of Invention

If an electrode-active material is continuously prepared according to the present invention, changes in the preparation conditions (reaction temperature, reaction pressure, or the like) are suppressed, and the continuous operation of a concentrating facility is possible. Thus, the maintenance costs of the process and the overall manufacturing costs are reduced. In addition, the stability of the processing facility under a high-temperature high-pressure environment can be improved, and thus the service life of the facility can be prolonged.

Further, the electrode-active material manufactured according to the present invention has an increased crystallinity. Thus, its particles are easier to handle in drying and sintering, and its performance as an electrode material is good.

### BRIEF DESCRIPTION OF DRAWINGS

FIG. 1 illustrates a process for preparing an electrode-active material according to an embodiment of the present invention.

FIG. 2 illustrates decompression equipment having a combination of a pressure control valve and a pipe-type (or tube-type) decompressor.

FIG. 3 illustrates decompression equipment having a combination of a pipe-type (or tube-type) decompressor and a pressure control valve.

FIG. 4 shows the results from the size analysis of the primary particles produced in example 1 using a PSA (particle size analyzer).

FIG. 5 shows the results from the size analysis of the primary particles produced in example 2 using a PSA.

FIG. 6 shows the results from the size analysis of the primary particles produced in comparative example 1 using a PSA.

FIG. 7 shows the results from the size analysis of the primary particles produced in comparative example 2 using a PSA.

FIG. 8 illustrates an example of the direction of fluid flow in a decompressor.

FIG. 9 illustrates another example of the direction of fluid flow in a decompressor.

### MODE FOR THE INVENTION

The present invention provides an apparatus for preparing an electrode-active material. The apparatus includes a reactor that produces an electrode-active material by using a high-temperature high-pressure hydrothermal synthesis method; and decompression equipment that decreases the pressure of the fluid containing the electrode-active material. The decompression equipment includes a pipe-type or a tube-type decompressor.

The pressure of the reactor may range from 150 to 700 bars, and the temperature of the reactor may range from 200 to 700° C.

The decompression equipment may reduce the pressure of the fluid, which is 230 to 300 bars, down to 1 to 40 bars.

The pipe-type and the tube-type decompressors may decrease the pressure of a fluid at a rate of 0.09 to 50 bars per meter of its length.

The fluid in the pipe-type or the tube-type decompressor may have a flow rate of 6.5 to 52 m/sec.

The pipe-type and the tube-type decompressors may include a combination of a plurality of pipes or a combination of a plurality of tubes. The inner diameters of these pipes or tubes may be identical or different.

The decompressor equipment may include a pressure control valve.

A pressure control valve may be positioned at the front of, in the rear of, or in the middle of the pipe-type or the tube-type decompressor.

The present invention provides a method for preparing an electrode-active material. The method includes forming an electrode-active material by using a high-temperature high-pressure hydrothermal synthesis method; and decreasing the pressure of a fluid containing the electrode-active material by using decompression equipment. The decompression equipment includes a pipe-type or a tube-type decompressor.

An example of a continuous-type high-temperature high-pressure hydrothermal synthesis method includes mixing water and raw materials of a cathode-active material in a reactor to form a slurry wherein the cathode-active material or a precursor of the cathode-active material is contained in a fluid; and introducing the slurry into a reactor in a supercritical environment at a temperature of 375 to 450° C. and a pressure of 230 to 300 bars to synthesize or crystallize the cathode-active material.

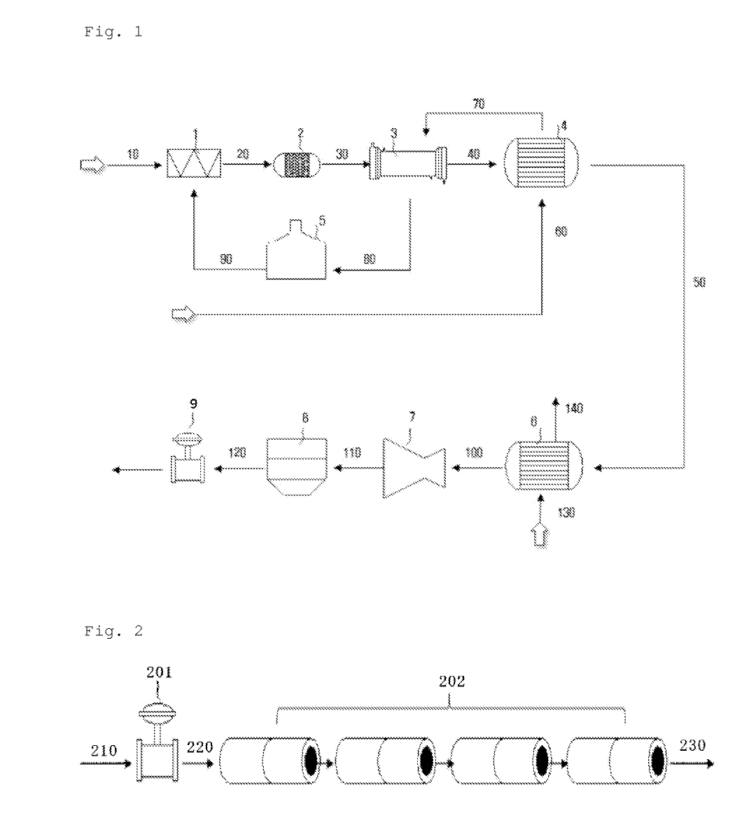

FIG. 1 illustrates an example of an apparatus for preparing an electrode-active material by using a continuous-type high-temperature high-pressure hydrothermal synthesis method according to the present invention. The apparatus includes a mixer 1; a reactor 2; coolers 3, 4 and 6; a decompressor 7; and a concentrator 8.

Raw materials of a cathode-active material are supplied to the mixer 1 through a passage 10. The mixer 1 mixes the raw materials to produce the cathode-active material and/or a precursor of the cathode-active material and discharges it through a passage 20. The mixer 1 may have a transition region where a fluid changes from a liquid phase to a state of high temperature and high pressure, together with a region of high temperature and high pressure.

In the reactor 2, the cathode-active material is synthesized or primary particles of the cathode-active material are crystallized and discharged through a passage 30. The fluid in the reactor 2 remains in a high-temperature high-pressure state.

The heat exchangers 3, 4 and 6 are placed in the rear of the reactor 2 and cool the fluid containing the cathode-active material from the high-temperature high-pressure state to a liquid phase state. The cooling may be carried out through multiple stages by using a plurality of heat exchangers. The heat exchanger 3 positioned closest to the reactor 2 among the multiple heat exchangers cools the fluid of the high-temperature high-pressure state to a subcritical state or to a liquid phase. Preferably, the cooler 3 is a double-pipe type heat exchanger.

A furnace 5 may be provided for pre-heating the deionized water which is discharged from the cooler 3 through a passage 80 and for introducing the water into the mixer 1. In addition, the decompressor 7 and the concentrator 8 may be provided at the rear of the cooler 3.

The decompressor 7 decreases the product mixture of a high pressure supplied through a passage 100 to a low pressure of 1 to 40 bars.

The concentrator 8 concentrates the fluid containing the cathode-active material supplied through a passage 110. The concentrator 8 may adopt a method which allows only liquid phase materials to pass by using a filter.

A decompressor 9 is a pressure control valve and decreases the pressure of the material discharged from the concentrator 8 approximately to the atmosphere pressure.

When only a pressure control valve (a back pressure regulator) is used as the decompressor, the particles of the electrode-active material collide with the tip of the valve and break the tip of the valve, possibly making it difficult to continuously perform the process operation for a long duration.

In the present invention, a pipe-type decompressor or a tube-type decompressor may be used as the decompression equipment. Alternatively, as the decompression equipment, a pipe-type decompressor or a tube-type decompressor can be used in combination with a decompressor of another type (for example, a pressure control valve). A tube-type decompressor or a pipe-type decompressor also functions to deagglomerate the agglomerates of the particles, as well as to reduce the pressure of the material. When the fluid passes through a tube-type or a pipe-type decompressor, the pressure of the fluid decreases due to friction with the interior of the decompressor, and the agglomerates of the primary particles contained in the fluid are deagglomerated.

FIG. 2 illustrates decompression equipment for decreasing the pressure of a target material to atmospheric level by conducting a second decompression with a tube-type or a pipe-type decompressor 202 after the high-pressure target material is partially decompressed by a pressure control valve 201.

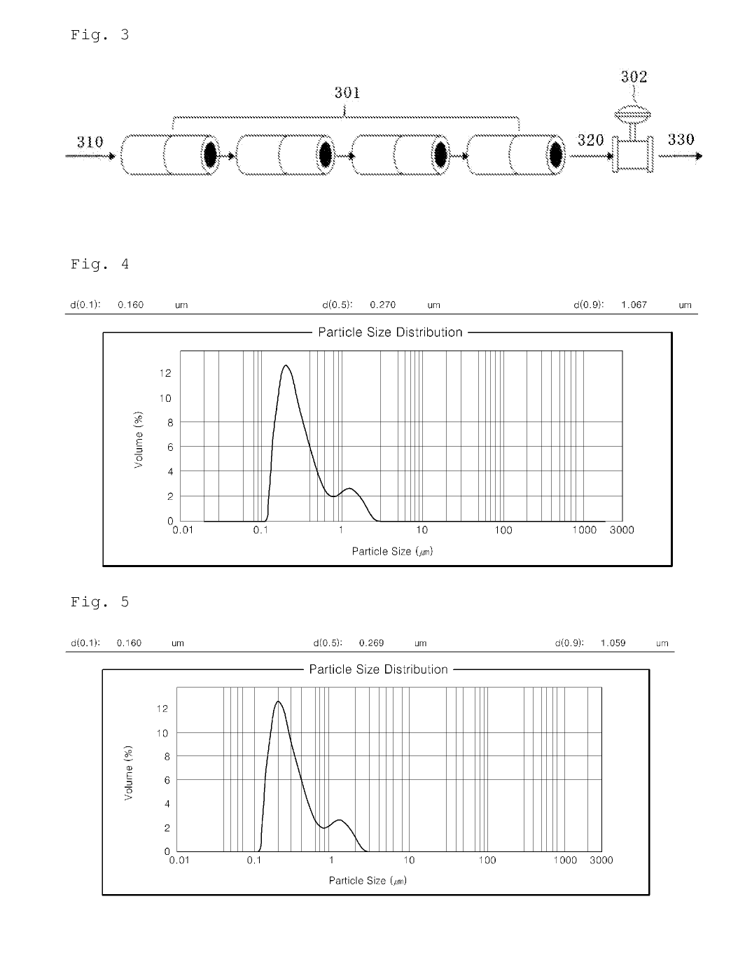

FIG. 3 illustrates decompression equipment for decreasing the pressure of the target material to atmospheric level by conducting a second decompression with a pressure control valve 302 after the target material of a high pressure is partially decompressed by a tube-type or a pipe-type decompressor 301.

In the present invention, reactants for preparing an electrode-active material react in a high-temperature high-pressure environment, and the reaction product is cooled to 100° C. or less through a heat exchanger. Thereafter, the product is decompressed by decompressor equipment, and is then concentrated by a concentrator.

In the present invention, water, as the fluid, may be in a supercritical state having a temperature of 375 to 450° C. and a pressure of 230 to 300 bars.

The fluid supplied to the decompression equipment may have a temperature of 30 to 200° C. and a pressure of 230 to 300 bars.

Decompression can be performed not only by a tube-type decompressor or a pipe-type decompressor, but also by concurrently using a pressure control valve, as shown in FIGS. 2 and 3. Such a pressure control valve may be provided at the front of, at the rear of, or in the middle of the tube-type decompressor or the pipe-type decompressor.

Further, inside the decompressor of the present invention, fluid may flow a region in a direction opposite to the direction of gravity, as shown in FIG. 8. However, it is preferred that the fluid does not flow a region in a direction opposite to gravity, so that the plugging of the passage by the fluid can be effectively prevented.

An electrode-active material prepared by the present invention can be a cathode-active material and an anode-active material for a secondary battery. Examples of the cathode-active materials of secondary batteries are oxides and non-oxides. Depending on their structures, the oxide materials can be classified into olivine structures (for example, LiMₓO₄), layered structures (for example, LiMO₂), spinel structures (for example, LiM₂O₄), nasicon structures (for example, Li₃M₂(XO₄)₃), and the like (wherein, M is an element selected from the group consisting of the transition metals and the alkali metals or is a combination of at least two elements selected therefrom). The average particle size of the cathode-active materials may be about 50 nm to about 5 μm.

Hereinbelow, the present invention is explained by referring to some examples.

### Example 1

Explanation is made with reference to FIG. 1.

The raw materials of LiFePO₄ supplied through a passage 10 and water in a super-critical state were mixed in a mixer 1 to produce a slurry containing a precursor of LiFePO₄. The slurry was introduced into a reactor 2 in a supercritical environment at a temperature of 386° C. and a pressure of 250 bars to synthesize LiFePO₄, and the resultant product of the synthesis was supplied to a double-pipe type heat exchanger 3 through a passage 30 and was cooled.

The fluid in the passage 30, before passing through the double-pipe type heat exchanger 3, was in the supercritical state. The fluid was cooled to 40 to 100° C. by passing through the double-pipe type heat exchanger 3, the secondary heat exchanger 4, and the third heat exchanger 6. Then, the resultant product was decompressed to 30 bars by the tube-type decompressor 7, and was then concentrated by the concentrator 8 until the particles of LiFePO₄ had a high concentration of about 20 wt %. The fluid containing the cathode-active material in the secondary heat exchanger 4 was cooled by the cooling water supplied through a passage 60. The cooling water discharged from the secondary heat exchanger 4 was supplied to the double-pipe type heat exchanger 3 through a passage 70. The concentrator used in this example was a filter. The internal pressure of the reactor 2 was maintained constant by controlling pressure decrease by adjusting the degree of opening of the pressure control valve 9 positioned at the rear of the concentrator, in accordance with pressure loss in the concentrator 8 as the concentration proceeded. As shown in FIG. 4, the average particle size of the cathode-active material was about 270 nm, and the maximum particle size thereof was about 2.512 μm.

### Example 2

LiFePO₄ was prepared under the same conditions as in example 1 except that only pipes were used as the decompression equipment 7, a centrifuge-type concentrator was used as the concentrator 8, and the separate pressure control valve 9 was not used at the rear of the concentrator.

After process operation was started, the internal pressure of the reactor remained constant, and the continuous operation was smoothly performed without the generation of pressure difference in the concentrator 8. As shown in FIG. 5, the average particle size of the cathode-active material was about 269 nm, and the maximum particle size thereof was about 2.512 μm.

### Comparative Example 1

LiFePO₄ was prepared under the same conditions as in example 1 except that only a pressure control valve was used as the decompression equipment 7, and the separate pressure control valve 9 was not present at the rear of the concentrator 8.

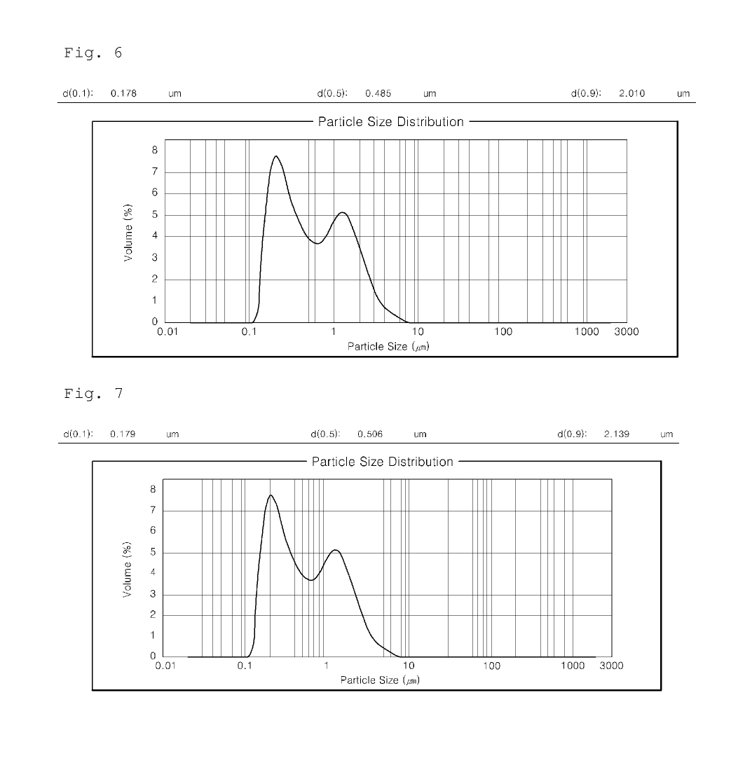

The pressure control valve was broken after 6 to 8 hours of process operation, making it difficult to control pressure. Accordingly, the entire process was stopped and the facility was replaced. Afterward, the same problem repeatedly occurred, necessitating frequent stops and starts of the process operation. As shown in FIG. 6, the average particle size of the cathode-active material was 485 nm, and the maximum particle size thereof was 6.607 μm.

### Comparative Example 2

LiFePO₄ was prepared under the same conditions as in example 1 except that only a pipe was used as the decompression equipment 7, and the separate pressure control valve 9 was not present at the rear of the concentrator 8.

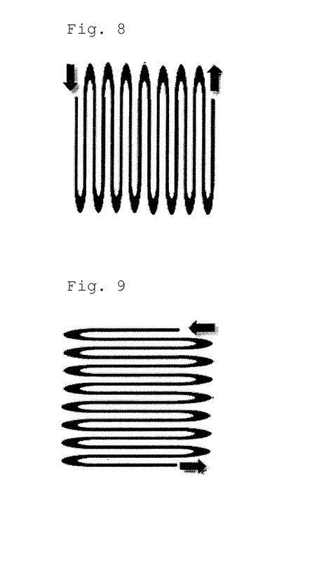

The internal pressure of the reactor 2 gradually increased after 1 hour of process operation. The flow rate of water needed to be continuously reduced in order to maintain the same operational conditions. After 10 hours of process operation, the amount of water was greatly reduced, and it was difficult to continue the operation, necessitating frequent stops and starts of the process operation. As shown in FIG. 7, the average particle size of the cathode-active material was 506 nm, and the maximum particle size thereof was 6.607 μm.

### INDUSTRIAL APPLICABILITY

If the present invention is used to continuously manufacture cathode-active material for a secondary battery, a stable and continuous process operation is possible, the maintenance cost of the process is reduced, and the service life of the process facility is prolonged. In addition, the cathode-active material manufactured by the method of the present invention possesses an increased particle crystallinity and improves the service life of batteries.

### EXPLANATION OF REFERENCE NUMERALS

1: Mixer

2: Reactor

3, 4, and 6: Cooler (heat exchanger)

5: Furnace

7: Decompressor

8: Concentrator

9: Pressure control valve

1. An apparatus for preparing an electrode-active material, comprising:
a reactor that produces the electrode-active material by using a hydrothermal synthesis method; and
decompression equipment that decreases the pressure of a fluid containing the electrode-active material,
wherein the decompression equipment includes a pipe-type or a tube-type decompressor.

2. The apparatus of claim 1, wherein the decompression equipment decreases the pressure of the fluid at 230 to 300 bars down to 100 bars or less.

3. The apparatus of claim 1, wherein the reactor is at a pressure of from 150 to 700 bars and a temperature of from 200 to 700° C.

4. The apparatus of claim 1, wherein the pipe-type and the tube-type decompressor reduce the pressure of the fluid at a rate of 0.09 to 50 bars per meter.

5. The apparatus of claim 1, wherein the pipe-type and the tube-type decompressor include a combination of a plurality of pipes or a combination of a plurality of tubes.

6. The apparatus of claim 1, wherein the decompressor equipment includes a pressure control valve.

7. The apparatus of claim 6, wherein the pressure control valve is positioned at the front of, at the rear of, or in the middle of the pipe-type or the tube-type decompressor.

8. A method for preparing an electrode-active material, comprising:
forming the electrode-active material by using a hydrothermal synthesis method; and reducing the pressure of a fluid containing the electrode-active material by using decompression equipment, wherein the decompression equipment includes a pipe-type or a tube-type decompressor.

9. The method of claim 8, wherein the decompression equipment reduces the pressure of the fluid at 230 to 300 bars down to 100 bars or less.

10. The method of claim 8, wherein the pipe-type and the tube-type decompressor reduce the pressure of the fluid at a rate of 0.09 to 50 bars per meter.

11. The method of claim 8, wherein the fluid in the pipe-type or the tube-type decompressor has a flow rate of 6.5 to 52 msec.

12. The method of claim 8, wherein the pipe-type and the tube-type decompressor include a combination of a plurality of pipes or a combination of a plurality of tubes.

13. The method of claim 8, wherein the decompressor equipment includes a pressure control valve.
